(19) United States
(12) Patent Application Publication
(10) Pub. No.: US 2011/0158503 A1
(43) Pub. Date: Jun. 30, 2011

(54) Reversible Three-Dimensional Image Segmentation

(75) Inventor: Zongxiang Yang, Superior, CO (US)

(73) Assignee: MICROSOFT CORPORATION, Redmond, WA (US)

(21) Appl. No.: 12/647,557

(22) Filed: Dec. 28, 2009

(51) Int. Cl. G06K 9/00

(52) U.S. Cl. 382/154; 382/173; 382/284

(57) ABSTRACT

Aspects of the subject matter described herein relate to reversible image segmentation. In aspects, candidate pairs for merging three dimensional objects are determined. The cost of merging candidate pairs is computed using a cost function. A candidate pair that has the minimum cost is selected for merging. This may be repeated until all objects have been merged, until a selected number of merging has occurred, or until some other criterion is met. In conjunction with merging objects, data is maintained that allows the merging to be reversed.

### BACKGROUND

Many devices give a view into internal organs of humans and other organisms. For example, a Computed Tomography (CT) scan obtains multiple two-dimensional images using X-rays. Magnetic resonance imaging (MRI) uses a strong magnet and sensors to obtain multiple two-dimensional images. In both cases, these two-dimensional images may then be stitched together to provide a three dimensional image of internal body organs and tissues. Identifying tumors and other abnormalities in these images is still a challenge. Similarly, analyzing structure and other characteristics in non-medical applications is also challenging.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

Briefly, aspects of the subject matter described herein relate to reversible image segmentation. In aspects, candidate pairs for merging three dimensional objects are determined. The cost of merging candidate pairs is computed using a cost function. A candidate pair that has the minimum cost is selected for merging. This may be repeated until all objects have been merged, until a selected number of merging has occurred, or until some other criterion is met. In conjunction with merging objects, data is maintained that allows the merging to be reversed.

This Summary is provided to briefly identify some aspects of the subject matter that is further described below in the Detailed Description. This Summary is not intended to identify key or essential features of the claimed subject matter, nor is it intended to be used to limit the scope of the claimed subject matter.

The phrase “subject matter described herein” refers to subject matter described in the Detailed Description unless the context clearly indicates otherwise. The term “aspects” is to be read as “at least one aspect.” Identifying aspects of the subject matter described in the Detailed Description is not intended to identify key or essential features of the claimed subject matter.

The aspects described above and other aspects of the subject matter described herein are illustrated by way of example and not limited in the accompanying figures in which like reference numerals indicate similar elements and in which:

### BRIEF DESCRIPTION OF THE DRAWINGS

FIG. 1 is a block diagram representing an exemplary general-purpose computing environment into which aspects of the subject matter described herein may be incorporated;

FIG. 2 is a block diagram that illustrates three exemplary 3D shape compactness measurements in accordance with aspects of the subject matter described herein;

FIG. 3 is an exemplary diagram that illustrates an exemplary 3D image that is represented with n 2D images in accordance with aspects of the subject matter described herein;

FIG. 4 is a graph that shows exemplary merging cost on one axis and exemplary merging sequence on another axis in accordance with aspects of the subject matter described herein;

FIG. 5 is a diagram that illustrates images for which merging is performed in accordance with aspects of the subject matter described herein;

FIG. 6 is a block diagram that represents an apparatus configured in accordance with aspects of the subject matter described herein;

FIGS. 7-8 are flow diagrams that generally represent actions that may occur in accordance with aspects of the subject matter described herein; and

FIGS. 9-10 are diagrams that illustrate different exemplary states of merging the images of FIG. 5 in accordance with aspects of the subject matter described herein.

### DETAILED DESCRIPTION

### Definitions

As used herein, the term “includes” and its variants are to be read as open-ended terms that mean “includes, but is not limited to.” The term “or” is to be read as “and/or” unless the context clearly dictates otherwise. The term “based on” is to be read as “based at least in part on.” The terms “one embodiment” and “an embodiment” are to be read as “at least one embodiment.” The term “another embodiment” is to be read as “at least one other embodiment.” Other definitions, explicit and implicit, may be included below.

### Exemplary Operating Environment

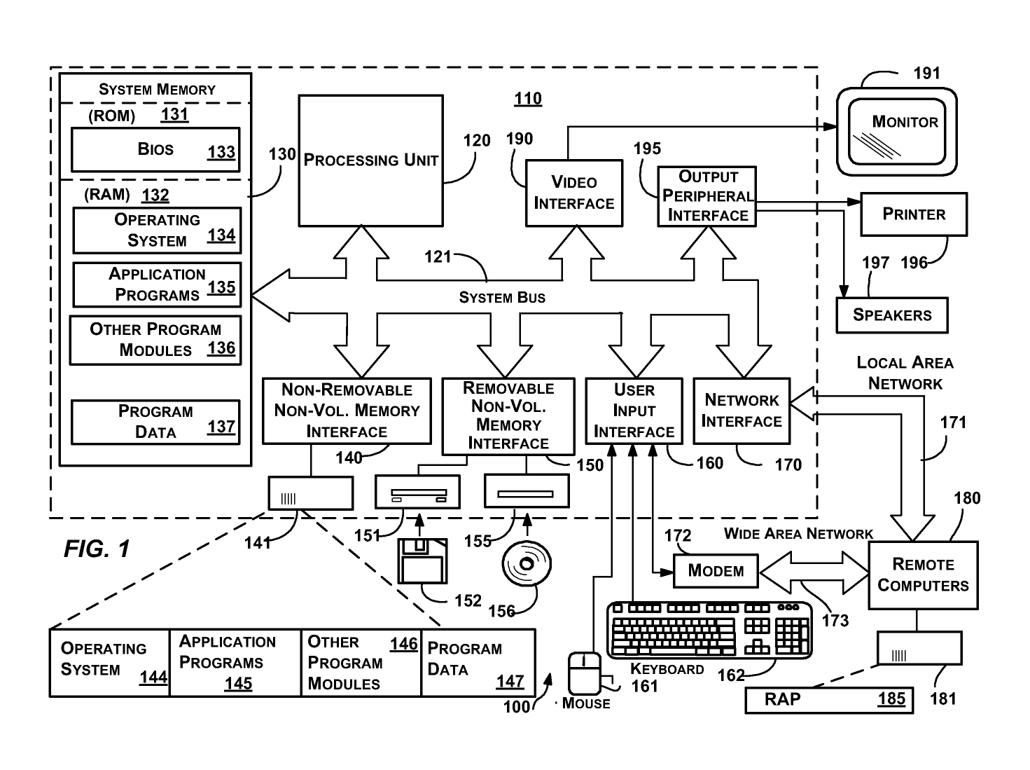

FIG. 1 illustrates an example of a suitable computing system environment 100 on which aspects of the subject matter described herein may be implemented. The computing system environment 100 is only one example of a suitable computing environment and is not intended to suggest any limitation as to the scope of use or functionality of aspects of the subject matter described herein. Neither should the computing environment 100 be interpreted as having any dependency or requirement relating to any one or combination of components illustrated in the exemplary operating environment 100.

Aspects of the subject matter described herein are operational with numerous other general purpose or special purpose computing system environments or configurations. Examples of well known computing systems, environments, or configurations that may be suitable for use with aspects of the subject matter described herein comprise personal computers, server computers, hand-held or laptop devices, multiprocessor systems, microcontroller-based systems, set-top boxes, programmable consumer electronics, network PCs, minicomputers, mainframe computers, personal digital assistants (PDAs), gaming devices, printers, appliances including set-top, media center, or other appliances, automobile-embedded or attached computing devices, other mobile devices, distributed computing environments that include any of the above systems or devices, and the like.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Program modules may be implemented in software and/or hardware. Aspects of the subject matter described herein may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing aspects of the subject matter described herein includes a general-purpose computing device in the form of a computer 110. A computer may include any electronic device that is capable of executing an instruction. Components of the computer 110 may include a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, Peripheral Component Interconnect Extended (PCI-X) bus, Advanced Graphics Port (AGP), and PCI express (PCIe).

The computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media.

Computer storage media includes both volatile and nonvolatile, removable and non-removable media implemented in any method or technology for storage of information such as computer-readable instructions, data structures, program modules, or other data. Computer storage media includes RAM, ROM, EEPROM, flash memory or other memory technology, CD-ROM, digital versatile discs (DVDs) or other optical disk storage, magnetic cassettes, magnetic tape, magnetic disk storage or other magnetic storage devices, or any other medium which can be used to store the desired information and which can be accessed by the computer 110.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disc drive 155 that reads from or writes to a removable, nonvolatile optical disc 156 such as a CD ROM or other optical media. Other removable/non-removable, volatile/nonvolatile computer storage media that can be used in the exemplary operating environment include magnetic tape cassettes, flash memory cards, digital versatile discs, other optical discs, digital video tape, solid state RAM, solid state ROM, and the like. The hard disk drive 141 is typically connected to the system bus 121 through a non-removable memory interface such as interface 140, and magnetic disk drive 151 and optical disc drive 155 are typically connected to the system bus 121 by a removable memory interface, such as interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies.

A user may enter commands and information into the computer 110 through input devices such as a keyboard 162 and pointing device 161, commonly referred to as a mouse, trackball, or touch pad. Other input devices (not shown) may include a microphone, joystick, game pad, satellite dish, scanner, a touch-sensitive screen, a writing tablet, or the like. These and other input devices are often connected to the processing unit 120 through a user input interface 160 that is coupled to the system bus, but may be connected by other interface and bus structures, such as a parallel port, game port or a universal serial bus (USB).

A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets, and the Internet.

When used in a LAN networking environment, the computer 110 is connected to the LAN 171 through a network interface or adapter 170. When used in a WAN networking environment, the computer 110 may include a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

### Reversible Segmentation

As mentioned previously, identifying tumors and other abnormalities in three-dimensional images is challenging. Similarly, analyzing structure and other characteristics in non-medical applications faces the same challenge. According to aspects of the subject matter described herein, image segmentation in three-dimensional space may be employed in analyzing three-dimensional (hereinafter 3D) images.

A 3D object may be formed from a one or more connected voxels. A voxel is similar to a pixel except that the voxel has three dimensions instead of two. A voxel may be cubic or non-cubic.

In image segmentation, 3D objects may be merged together using a merging cost function. A merging cost function may take various features into account including:

1. Radiometric similarity. The smaller the radiometric differences are between the two 3D objects, the smaller the merging cost.

2. Texture similarity. The more similar textures of two 3D objects are, the smaller the merging cost. In one approach, a standard deviation may be used for measuring texture. In other approaches entropy and/or angular second moment may also be used.

3. Distance. The distance between two 3D objects may also be taken into account. The smaller the distance is, the smaller the merging cost.

4. The shape of the 3D objects after merging may also be taken into account. The cost function may favor merging that creates ‘compact’ 3D objects. One compactness measurement criteria for 3D objects is

$$C = \frac{36 π {V}^{2}}{{A}^{3}} .$$

This compactness measurement criterion uses a sphere as a reference. When integrating compactness into a cost function, the constant term 36π may be omitted.

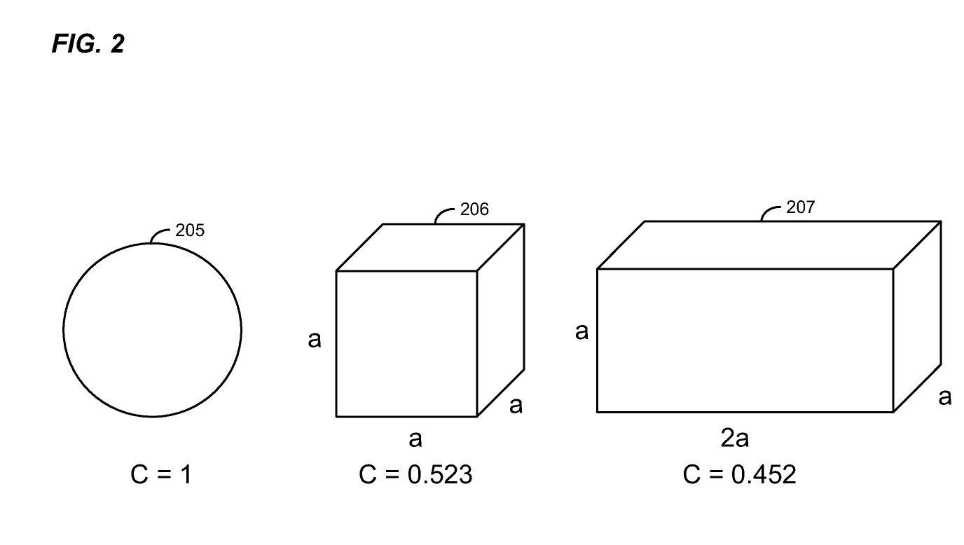

FIG. 2 is a block diagram that illustrates three exemplary 3D shape compactness measurements in accordance with aspects of the subject matter described herein. FIG. 2 illustrates a sphere 205, a cube 206, and a cuboid 207. The compactness measures for the sphere 205, cube 206, and cuboid 207 are 1, 0.523, and 0.452, respectively. The three 3D shapes illustrated are not intended to be all-inclusive or exhaustive of the types of 3D shapes for which compactness may be measured. Indeed, the teachings herein may be applied to virtually any shape. In general, the more spread out a 3D shape is, the smaller its measure of compactness.

In real world applications, all or a subset of above mentioned criteria and/or other criteria may be selected on an experimental basis. The criteria selected for a merging cost function may be different from one domain to another.

On exemplary merging cost function is:

$$mc = {‖ Pi - Pj ‖}^{α} \times {‖ Ti - Tj ‖}^{β} \times \frac{1}{S ( Vi , Vj )} \times d ( Vi , Vj ) \times {( \frac{{A}^{3}}{{V}^{2}} )}^{λ}$$

where:

∥Pi−Pj∥^{α} is the radiometric similarity measure between two volumetric regions. Pi and Pj are the mean value of the radiometric voxel values of the 3D regions. α is the weight term used to control the influence of the factor. The default for a is 1.

∥Ti−Tj∥^{β} is the texture similarity measure between two volumetric regions. Ti and Tj are the standard deviation of the radiometric voxel values of the 3D regions. β is the weight term used to control the influence of the factor. The default for β is 1.

S(Vi,Vj) is the area of the contact surface shared between the two volumetric regions.

d(Vi,Vj) is the distance between the centroids of the two volumetric regions.

V is the total volume of the 3D region after merging.

A is the total surface area of the 3D region after merging.

λ is a weight term used to control the influence of shape consideration, typically in the range of 0 and 1. λ=0 indicates the shape consideration is not taken into account. The default value is 0.5.

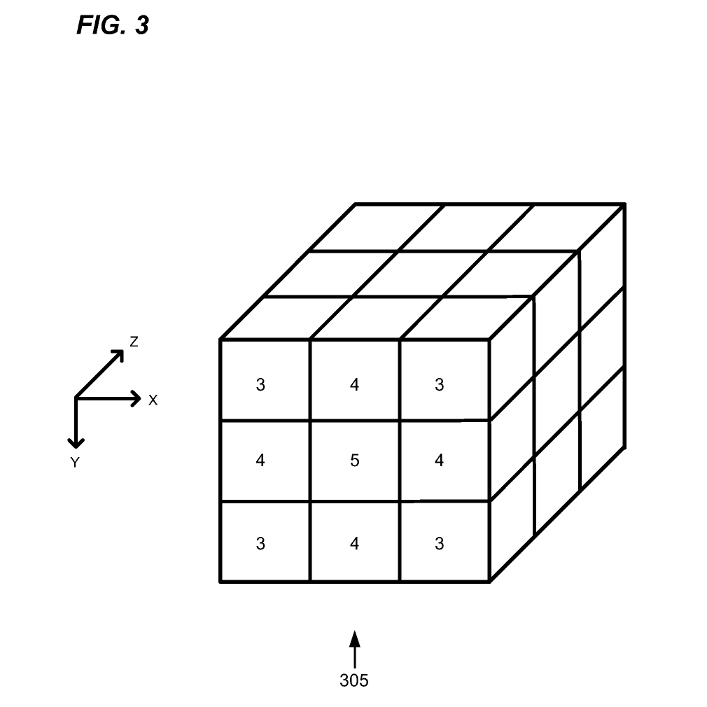

FIG. 3 is an exemplary diagram that illustrates an exemplary 3D image that is represented with n 2D images in accordance with aspects of the subject matter described herein. The z-coordinates are implicitly given as illustrated in FIG. 3. As illustrated, it can be seen that a 2D-pixel may be extended to be viewed as a 3D-voxel. Voxels from a sequence of image slices may or may not be cubic due to the nature of the image process. For example, the voxel Z dimension from Computed Tomography (CT) data is generally larger than the X and Y dimensions. Without losing generality, a voxel may have a dimension of 1×1×d (depth), and a 3D image may be represented by a number of nz sequence of 2D images with a dimension of (nx, ny). Merging all the voxels into one region may involve nx*ny*nz−1 merge steps. The number of neighboring voxels is illustrated on the front-facing voxels 305 with 6 being the maximum number of neighboring voxels initially.

One exemplary reversible 3D segmentation procedure is detailed as follows.

For initialization, first each voxel may be taken as a 3D object. The term 3D object represents a 3D surface. Some exemplary properties of a 3D object include:

Id—an identifier that is determined by an integer-triplet (l, m, n). For example, Id may be computed from a function that takes the three parameters (l, m, n) as follows: Id=n*nx*ny+m*nx+l.

Vi—volume (1×1×d=d).

Pi—image pixel value.

The centroid of the voxel in X/Y/Z dimension is (1+0.5, m+0.5, d*(n+0.5)).

The total surface area is (2+4d).

The neighborhood information may also be stored, for example, as a list of neighboring objects. For example, neighborhood information may include neighboring volume Id (Nid) (l,m,n) and contact surface area Sj.

When there are nz images and nx*ny pixels in each image, there is a total number of (nx*ny*nz) objects before merging begins. Each object may also maintain a list of component voxels {vi (l,m,n)}. This list may have only one element (e.g., the Id of the voxel itself) before merging begins.

Objects may be stored in a sortable collection {Oi}. The merge counter that keeps track of the order of merging may initially be set to 0, (e.g., m_counter=0). A merging sequence list (m_seq_list) may be used to record the merging sequence. Each element of the merging sequence list may include two object Ids (e.g., fId and tId) where fId is the object Id (e.g., the larger Id value) that is merged into the other object (e.g., ‘tId’: the smaller Id value) during a merge. Initially, the merging sequence list may start as empty.

As another step of initialization, all possible 3D object merging pairs may be computed. Each merging pair may include the following information: pid (pair id), Id1 (Id of object 1), Id2 (Id of object 2), and m_cost (merging cost). The merging cost may be calculated using the equation previously described.

The distance between the two objects may be calculated based on the centroids of the objects. For example, the distance may be calculated using the following function: distance=sqrt((x2−x1)̂2+(y2−y1)̂2+(z2−z1)̂2).

The merging cost calculation may also involve the total surface area and volume information A and V which may be computed as follows: V=V1+V2, A=A1+A2−2*S12, where V1 and V2 are the volume of object 1 and 2, A1, A2 are the surface areas of object 1 and 2, S12 is the contact surface area of object 1 and object 2.

For the purpose of computational efficiency, all the merging pairs may be put into a sortable collection {Pi} such as a tree data structure so that the node with minimum cost can be quickly retrieved or deleted, and new nodes can be efficiently inserted. Initially, there is a total number of (nx−1)*ny*nz+(ny−1)*nx*nz+(nz−1)*nx*ny candidate merging pairs.

Once initialization has been performed, object merging may begin. To do this, from all the candidate merging pairs, the algorithm finds the merging pair with the minimum merging cost, merges the two 3D objects of the pair into one, and updates the neighborhood relations.

For example, object 1 and object 2 may constitute the minimum cost merging pair. In merging object 1 with object 2, the object with the larger Id may be merged into the object with the smaller Id object. For example, if Id1<Id2, then set V=V1+V2 as the volume of the new object and Id1 (the smaller value of Id1 and Id2) as the Id of the new object after merge. The new centroid of the merged object may be computed with the equation: (n1*p1(x,y,z)+n2*p2(x,y,z))/(n1+n2), where n1, n2 are the number of voxels in objects 1 and 2. The surface area of the merged object may then be updated to reflect the merging. All the elements from the component voxel list of object 2 are added to the component voxel list of object 1. Object 2 is not deleted and its component voxel list is kept intact for the sake of reversible operation.

For each object O₂ⱼ that is a neighboring object of object 2, the following updates are performed:

1. If O₂ⱼ is not a neighboring object of object 1, add O₂ⱼ into object 1's neighboring object list with touching surface area. Also, a change is made in data structures such that O₂ⱼ is now neighboring with object 1 instead of object 2. Furthermore, the object's id and merge cost in the related pairs in the candidate merging pair collection is updated.

2. If O₂ⱼ is also a neighboring object of object 1, object 1's touching surface with O₂ⱼ is updated so that S=S1+S2, where S1 is the previous touching surface area between object 1 and O₂ⱼ and S2 is the previous touching surface area between object 2 and O₂ⱼ. Also, a change is made in the data structures so that O₂ⱼ's new touching surface with object 1 is S (S1+S2).

To complete an iteration of object merging, object Id2 is added to the merging sequence list (m_seq_list).

The actions above are repeated with the next minimum merging cost and this is repeated until all voxels are merged into one region.

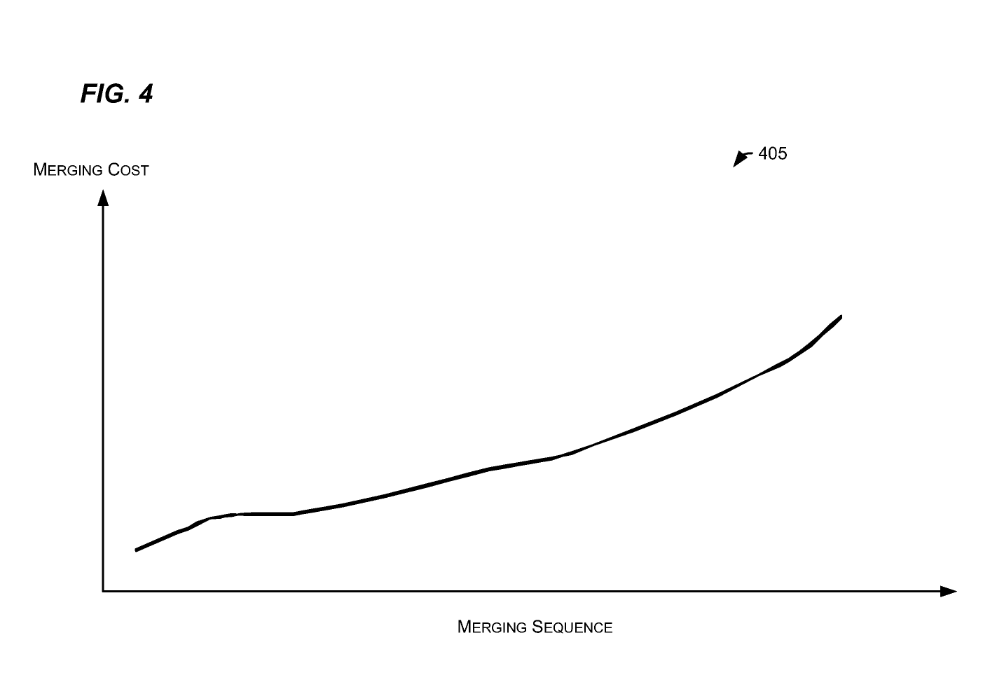

In conjunction with merging objects, data indicating the sequence of objects merged and the merge cost may also be stored. Once all the voxels are merged into one region, the merge cost for every merging step is stored. FIG. 4 is a graph that shows exemplary merging cost on one axis and exemplary merging sequence on another axis in accordance with aspects of the subject matter described herein. As can be seen by the graph 405, the merging cost increases as the merging sequence increases.

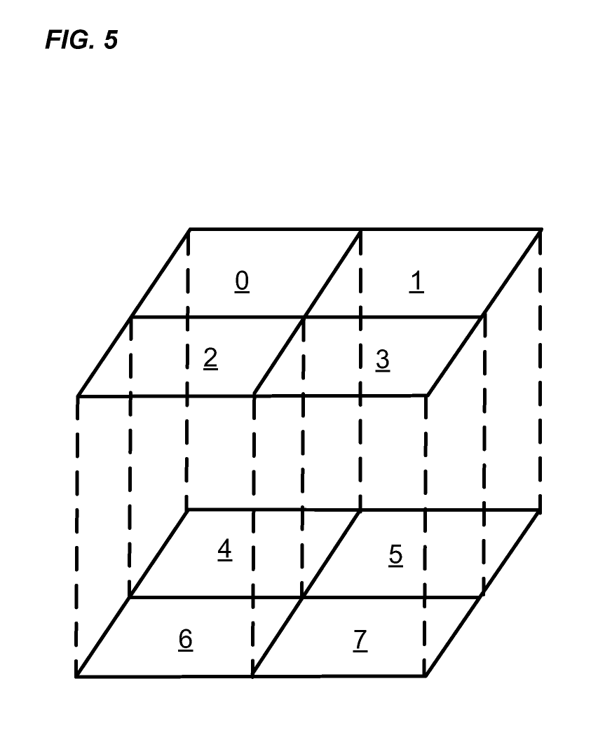

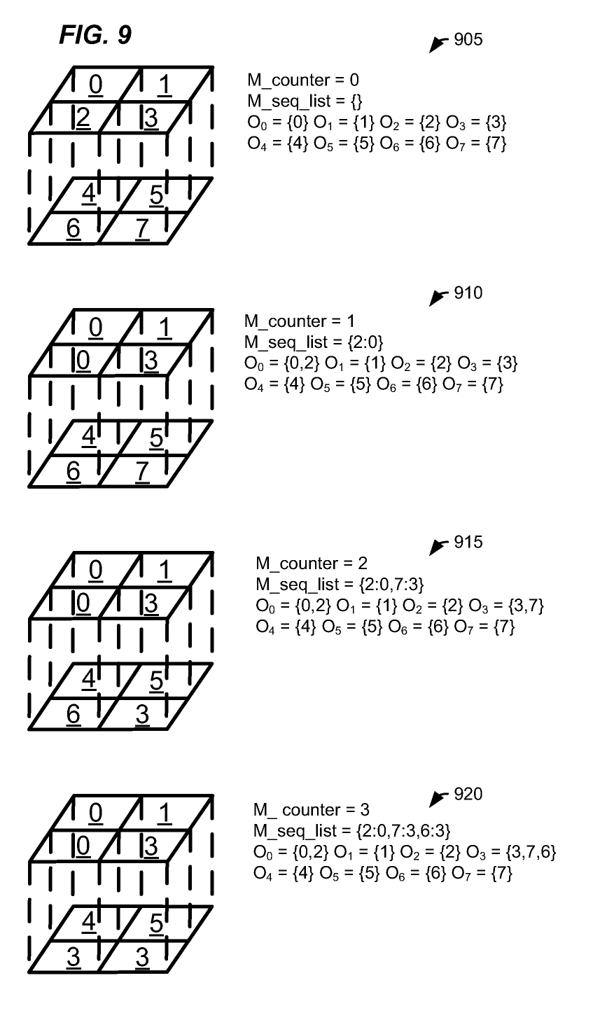

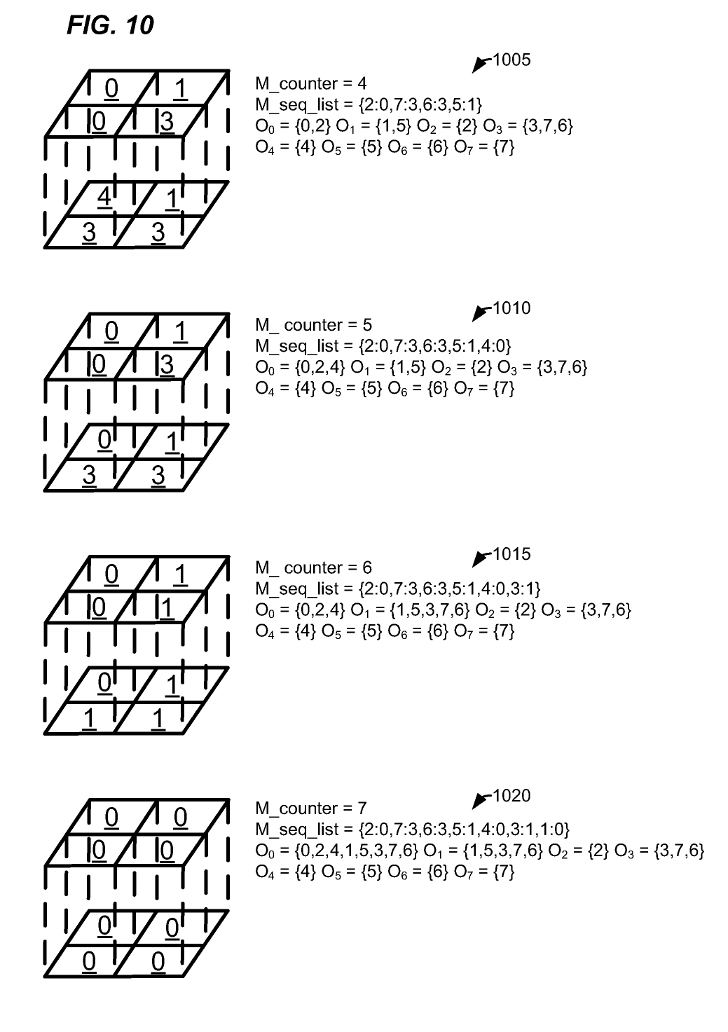

FIG. 5 illustrates two 2×2 images for which merging is performed in accordance with aspects of the subject matter described herein. The objects are labeled 0-7. After initialization that has been described above, merging of objects may occur. To illustrate one exemplary merging, a list of merging steps is described below. This list is exemplary only and depends on an exemplary cost function applicable to the images in FIG. 5. The state of merging the objects is also illustrated in FIGS. 9-10 where the numbers on the surfaces illustrate the regions associated with each object. The merging steps include:

1. At step 1, none of the objects are merged. At this step, M_counter=0, m_seq_list={ }, O₀={0}, O₁={1}, O₂={2}, O₃={3}, O₄={4}, O₅={5}, O₆={6}, and O₇={7}. Oⱼ, j=0 to 7, contains the component voxel list of each of the 7 initial objects, which initially only include one voxel surface each. The step is illustrated as state 905 in FIG. 9 where each region is labeled with a number (e.g., 0-7). Before merging, each object is associated with its own region.

2. At step 2, objects 0 and 2 are merged. At this step, M_counter=1, M_seq_list={2:0}, O₀={0,2}, O₁={1}, O₂={2}, O₃={3}, O₄={4}, O₅={5}, O₆={6}, and O₇={7}. Notice that the sequencing list (M_seqlist) indicates that voxels in the objects 0 and 2 were merged in this step. Also note that in the object list, that Oₒ now refers to the original objects 0 and 2. This is consistent with merging the voxels into the identifier with the lower value.

This result of this step is illustrated as state 910 in FIG. 9. In state 910 of FIG. 9, the label for region 2 of state 905 has been relabeled with a 0 to indicate that it now belongs to region 0. This relabeling in FIG. 9 is done for illustrative purposes only and may not be actually performed by the algorithm. For example, the algorithm performing the merge does not need to (but may) relabel the objects in a data structure as long as the algorithm reflects the regions to which the objects belong in the data structure.

3. At step 3, the objects 3 and 7 are merged. At this step, M_counter=2, M_seq_list={2:0,7:3}, O₀={0,2}, O₁={1}, O₂={2}, O₃={3,7}, O₄={4}, O₅={5}, O₆={6}, and O₇={7}. The result of this step is illustrated in state 915 of FIG. 9. In state 915 of FIG. 9, the label for the region 7 of state 910 has been relabeled with a 3 to indicate that it now belongs to region 3. Note that the sequencing list indicates the order of the merging steps. Also note that O₃ now refers to original objects 3 and 7.

4. At step 4, the objects 3 and 6 are merged. At this step, M_counter=3, M_seq_list={2:0,7:3,6:3}, O₀={0,2}, O₁={1}, O₂={2}, O₃={3,7,6}, O₄={4}, O₅={5}, O₆={6}, and O₇={7}. The result of this step is illustrated in state 920 of FIG. 9. In state 920 of FIG. 9, the label for the region 6 of state 915 has been relabeled with a 3 to indicate that it now belongs to region 3. Note that O₃ now refers to original objects 3, 7, and 6.

5. At step 5, the objects 1 and 5 are merged. At this step, M_counter=4, M_seq_list={2:0,7:3,6:3,5:1}, O₀={0,2}, O₁={1,5}, O₂={2}, O₃={3,7,6}, O₄={4}, O₅={5}, O₆={6}, and O₇={7}. The result of this step is illustrated in state 1005 of FIG. 10. In state 1005 of FIG. 10, the label for the region 5 of state 920 of FIG. 9 has been relabeled with a 1 to indicate that it now belongs to region 1. Note that O₁ now refers to original objects 1 and 5.

At step 6, the objects 0 and 4 are merged. At this step, M_counter=5, M_seq_list={2:0,7:3,6:3,5:1,4:0}, O₀={0,2,4}, O₁={1,5}, O₂={2}, O₃={3,7,6}, O₄={4}, O₅={5}, O₆={6}, and O₇={7}. The result of this step is illustrated in state 1010 of FIG. 10. In state 1010 of FIG. 10, the label for the region 4 of state 1005 has been relabeled with a 0 to indicate that it now belongs to region 0. Note that O₀ now refers to original objects 0, 2, and 4.

At step 7, the objects 1 and 3 are merged. At this step, M_counter=6, M_seq_list={2:0,7:3,6:3,5:1,4:0,3:1}, O₀={0,2,4}, O₁={1,5,3,7,6}, O₂={2}, O₃={3,7,6}, O₄={4}, O₅={5}, O₆={6}, and O₇={7}. The result of this step is illustrated in state 1015 of FIG. 10. In state 1015 of FIG. 10, the label for the region 3 of state 1010 has been relabeled with a 1 to indicate that it now belongs to region 1. Note that O₁ now refers to original objects 1, 5, 3, 7, and 6.

At step 8, the objects 0 and 1 are merged. At this step, M_counter=7, M_seq_list={2:0,7:3,6:3,5:1,4:0,3:1,1:0}, O₀={0,2,4,1,5,3,7,6}, O₁={1,5,3,7,6}, O₂={2}, O₃={3,7,6}, O₄={4}, O₅={5}, O₆={6}, and O₇={7}. The result of this step is illustrated in state 1020 of FIG. 10. In state 1020 of FIG. 10, the label for the object 1 of state 1015 has been relabeled with a 0 to indicate that it now belongs to the group identified with 0. Note that O₀ now refers to original objects 0, 2, 4, 1, 5, 3, 7, and 6. Also note that at this step, all the original objects have now been merged into a single object.

Through analyzing the merge cost sequence of data with domain specific knowledge, a user may select a segmentation result that is neither over segmented nor under segmented. In addition to the basic statistics such as mean and standard deviation of the merging costs, other advanced statistics such as autocorrelation can be used to identify a desirable segmentation result that is meaningful and easier to analyze. Because the merge sequence is recorded, a user may easily reconstruct the segmentation result and even select a desired segmentation result through a trial-and-error approach.

The following simple steps may be taken to reconstruct the segmentation image at a specific merge step, (e.g., m_counter=n). For example, referring to FIG. 4, the target may be n=5. To facilitate reconstructing segmentation at multiple merging steps, a copy of final merging status information may be stored. An object collection (e.g., a container L) may be used to contain all the object ids that make up the segmented regions at the specified merge step. Another variable such as tgt_m_counter may be used for measuring current merging step. Initially, tgt_m_counter may be set to nx*ny*nz−1. The steps to reconstruct the segmentation image may include:

1. First, start with the last merge step snapshot. The last merge step snapshot includes every region's component voxel list. Then, process each element in the merge sequence list backward (e.g., starting with the last element, then the second to last, and so on) until the desired merge step is reached. Identify the involved object Ids (e.g., {fId:tId}). Add ‘tId’ to C.

C is an object collection, container, or the like that is used to contain the smallest object ids of each of the segmented regions at a specified merge step. For example, a sorted list L may be used represent C for computational efficiency. In FIG. 5 after all merging is completed, L={0}. This corresponds to state 1020 of FIG. 10.

2. Obtain the component voxel lists for the object ‘fId’ and ‘tId’ objects shown in the m_seq_list (e.g., the from_list and to_list). Remove the ‘from_list’ from_the ‘to_list’ and update the object ‘tId’ volume information as follows: V(tId)=V(tId)−V(fId). Decrease the current tgt_m_counter by 1. Add ‘fId’ to C. For example, referring to FIG. 10, at state 1020, fId=1, tId=0, ‘from_list’ is O₁={1,5,3,7,6}, ‘to_list’ is O₀={0,2,4,1,5,3,7,6}. Region 0's voxel list becomes O₀={0,2,4} after the voxel list O₁ is removed from it. The merge sequence list becomes M_seq_list={2:0,7:3,6:3,5:1,4:0,3:1} after the last merge pair ‘1:0’ is removed. The result of these actions is the state 1015 of FIG. 10. In state 1015, L={0,1}.

3. Loop through step 2 until tgt_m_counter is equal to the specified m_counter. In FIG. 5, when tgt_m_counter=5, L={0,1,3}. In this case, the segmented regions contain region 0, 1, and 3 while each region holds all the voxels belonging to that region. Because a voxel Id=n*nx*ny+m*nx+1, its 3D component (m,n,l) may be derived as follows: n=Id/(nx*ny), m=(Id−n*nx*ny)/nx, 1=(Id−n*nx*ny−m*nx) % nx. As a result, the exact pixel location within a series of 2D images of the voxel belonging to a 3D region may be determined.

In one embodiment, merging may cease before all the voxels are merged into one region. For example, the merging process may stop after a specified number of regions is reached. As long as the merge sequence list ‘m_seq_list’ is maintained, reverse operations may be employed to obtain a previous step.

Maintaining a voxel list for each region may take a large amount of memory. In some cases, it may not be feasible to put the voxel lists in main memory. In these cases, the voxel lists may be stored on a hard disk. A voxel list may be read into main memory when a region associated with the voxel list is involved. Furthermore, to save computational effort during revere operations, multiple snapshot states may be stored.

Those skilled in the art may recognize various benefits that may be obtained by following aspects of the subject matter described herein. One or more of these benefits may be obtained, depending on implementation. Some exemplary benefits include:

By allowing the segmentation process to be reversible, a user is able to select a result that is meaningful and revealing, and to do so in an effective and efficient way.

By allowing the segmentation process to run a complete cycle (e.g., from not merging enough (each voxel is a region) to merging too much (all voxels merged into one region)), a user is able to analyze the pattern of how the merging costs change with each merging step. Such pattern may be used as clues in determining a desirable scale space in which the domain specific problem becomes easier to solve.

By introducing shape and distance merging criteria in 3D space, the segmentation result may be easier for a human to visually perceive.

By viewing segmentation as a step by step, progressive process, a user is able to apply different merging criteria on different stages, doing so in a way that has the physical significance of actual processes.

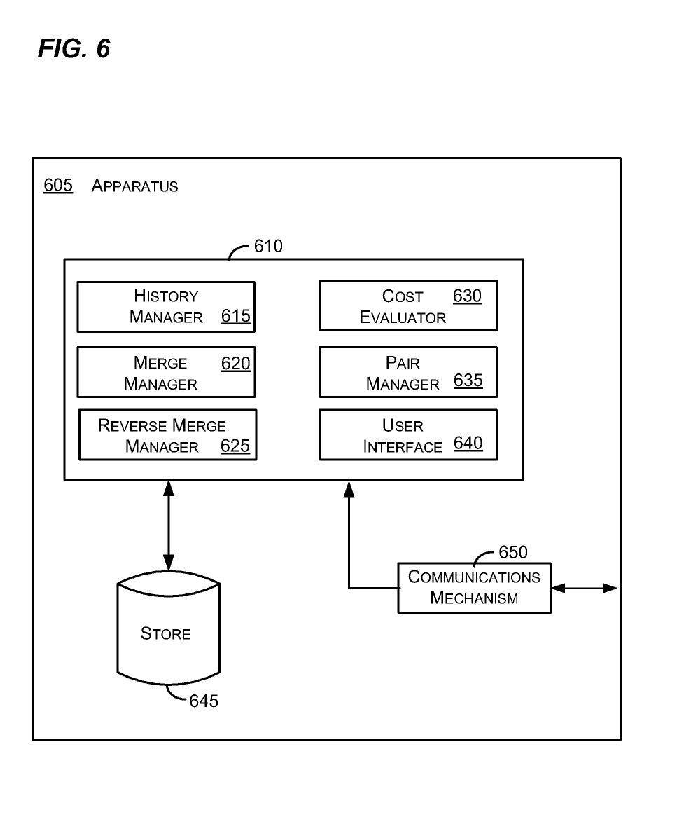

FIG. 6 is a block diagram that represents an apparatus configured in accordance with aspects of the subject matter described herein. The components illustrated in FIG. 6 are exemplary and are not meant to be all-inclusive of components that may be needed or included. In other embodiments, the components and/or functions described in conjunction with FIG. 6 may be included in other components (shown or not shown) or placed in subcomponents without departing from the spirit or scope of aspects of the subject matter described herein. In some embodiments, the components and/or functions described in conjunction with FIG. 6 may be distributed across multiple devices.

Turning to FIG. 6, the apparatus 605 may include merging components 610, a store 645, a communications mechanism 650, and other components (not shown). The apparatus 605 may comprise one or more computing devices. Such devices may include, for example, personal computers, server computers, hand-held or laptop devices, multiprocessor systems, microcontroller-based systems, set-top boxes, programmable consumer electronics, network PCs, minicomputers, mainframe computers, cell phones, personal digital assistants (PDAs), gaming devices, printers, appliances including set-top, media center, or other appliances, automobile-embedded or attached computing devices, other mobile devices, distributed computing environments that include any of the above systems or devices, and the like. An exemplary device that may be configured to act as the apparatus 605 comprises the computer 110 of FIG. 1.

The merging components 610 may include a history manager 615, a merge manager 620, a reverse merge manager 625, a cost evaluator 630, a pair manager 635, a user interface 640, and other components (not shown).

The communications mechanism 650 allows the apparatus 605 to communicate with other entities. For example, the communications mechanism 650 may allow the apparatus 605 to communicate with an image acquisition source or server hosting image data. The communications mechanism 650 may be a network interface or adapter 170, modem 172, or any other mechanism for establishing communications as described in conjunction with FIG. 1.

The store 645 is any storage media capable of providing access to images and associated data. For example, the store 645 may be used to store history data that indicates a sequence of merge operations. The store 645 may comprise a file system, database, volatile memory such as RAM, other storage, some combination of the above, and the like and may be distributed across multiple devices. The store 645 may be external, internal, or include components that are both internal and external to the apparatus 605.

The history manager 615 may be operable to update a data structure to indicate a sequence of merges of the three-dimensional objects, such that the merges are reversible. The history manager may store the data structure on the store 645. The history manager 615 may provide the sequence of merges together with any associated data to the reverse merge manager 625 as requested.

The merge manager 620 may be operable to merge objects of candidate pairs into merged objects and to update properties of the merged objects based on properties of the objects of the candidate pairs. For example, in merging two objects, the merge manager 620 may determine a new volume, surface area, adjacent objects, and other properties of the newly merged object.

The reverse merge manager 625 may be operable to operable to use the data structure stored by the history manager 615 to reverse one or more merges of the candidate pairs. This reverse merging may be performed as described previously.

The cost evaluator 630 may be operable to determine merging costs for merging each candidate pair. The cost evaluator 630 may do this, for example, by evaluating a cost function that accounts for radiometric similarity, texture similarity, distance, and compactness of two potential objects to merge.

The pair manager 635 may be operable to determine candidate pairs for merging three-dimensional objects. Each candidate pair may include two of the three-dimensional objects.

The user interface 640 may be operable to receive input from a user regarding merging and reverse-merging operations. The user interface 640 may also be used to provide output data (e.g., the results of a merge or reverse merge) to the user.

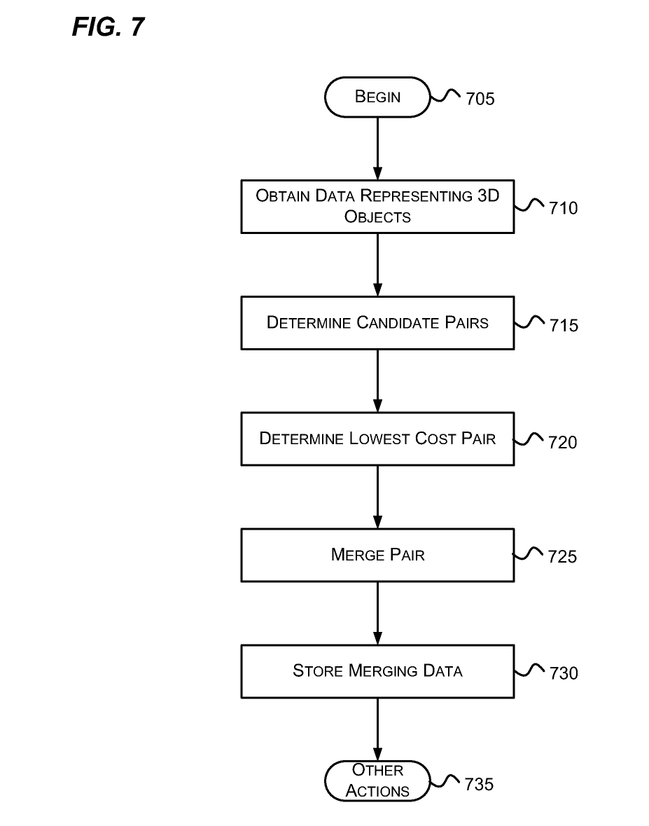

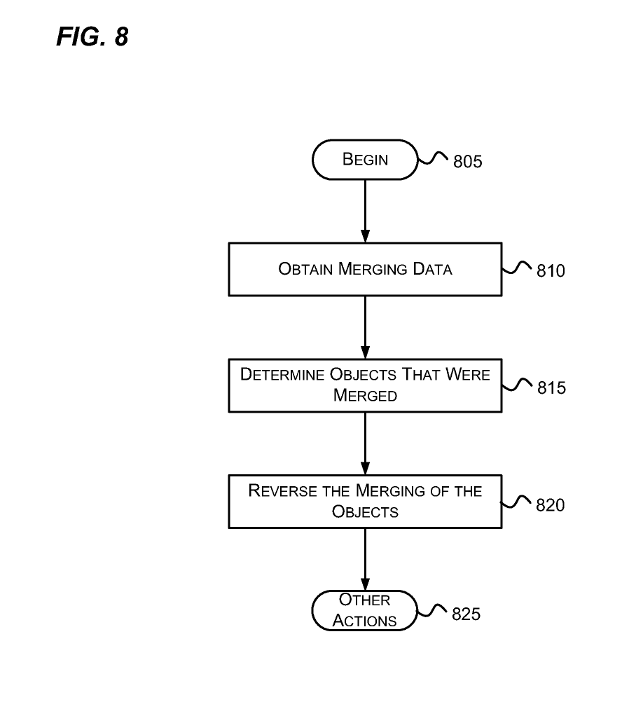

FIGS. 7-8 are flow diagrams that generally represent actions that may occur in accordance with aspects of the subject matter described herein. For simplicity of explanation, the methodology described in conjunction with FIGS. 7-8 is depicted and described as a series of acts. It is to be understood and appreciated that aspects of the subject matter described herein are not limited by the acts illustrated and/or by the order of acts. In one embodiment, the acts occur in an order as described below. In other embodiments, however, the acts may occur in parallel, in another order, and/or with other acts not presented and described herein. Furthermore, not all illustrated acts may be required to implement the methodology in accordance with aspects of the subject matter described herein. In addition, those skilled in the art will understand and appreciate that the methodology could alternatively be represented as a series of interrelated states via a state diagram or as events.

Turning to FIG. 7, at block 705, the actions begin. For example, referring to FIG. 6, the user interface 640 may receive input from a user that indicates that merging is to commence.

At block 710, data representing 3D objects may be obtained. For example, referring to FIG. 6, the communications mechanism 650 may be used to obtain this data from a source external to the apparatus 605.

At block 715, candidate pairs for merging the three-dimensional objects are determined. For example, referring to FIG. 635, the pair manager 635 may determine pairs of objects that are adjacent to each other and may populate a data structure to indicate these pairs.

At block 720, a lowest cost pair of the candidate pairs is determined. The lowest cost pair has a minimum merging cost, but other candidate pairs may also have the same merging cost. In other words, determining a lowest cost pair of the candidate pairs may include determining a candidate pair that has a merging cost that is no larger than any other merging cost of the other candidate pairs.

At block 725, the objects of the lowest cost pair are merged. For example, referring to FIG. 5, the objects 0 and 2 may be merged.

At block 730, merging data is stored. For example, referring to FIG. 6, the history manager may store data indicative of the lowest cost pair and indicative of merging order of pairs of the three dimensional objects.

At block 735, other actions, if any, may be performed.

Turning to FIG. 8, at block 805, the actions begin. For example, referring to FIG., the user interface 640 may receive input from a user that indicates that a reverse merging operation is to commence.

At block 810, a data structure is obtained that indicates merging steps performed to merge three-dimensional objects. The merging steps indicate a sequence in which pairs of the three dimensional objects were merged. Obtaining the data structure may include obtaining identifiers of merged objects in an order in which the merged objects were merged. Obtaining the data structure may also include obtaining data that indicates voxels included in each object. The data structure may also include other information about the 3D objects such as the information described previously. For example, referring to FIG. 6, the history manager 615 may be used to obtain the data structure from the store 645.

At block 815, the data structure is used to determine two of the three-dimensional objects that were merged in a merging step of the merging steps. For example, referring to FIGS. 5 and 6, the reverse merge manager 625 may determine that the objects 0 and 2 were merged at a particular merging step.

At block 820, the merging of the objects is reversed. This may involve, for example, removing voxels of one of the two three-dimensional object from a merged object that includes voxels from the two three-dimensional objects and other actions previously described. For example, referring to FIGS. 5 and 6, the reverse merge manager 625 may reverse the merge of the objects 0 and 2 and may update the data structure as has been described previously.

At block 825, other actions, if any, may be performed.

At block 510, a request for content is received. The request may come from a browser component of a client. The request may be received at the content server or at a component that is “logically” between the content server and the browser component. The term logically in this context indicates a component that receives the request before the request (or a request derived from the request) is sent to the content server. For example, referring to FIG. 2, a request from the browsing component 216 of the client 207 may be received by the content service 206 or a pagination component (not shown) that resides on the client 207.

At block 515, the content is obtained from the server. For example, referring to FIG. 2, the pagination component 220 of the content service 206, the pagination component 221 of the content server 205, or a pagination component of the client 207 may obtain content corresponding to a Web page from the content server 205.

At block 520, page breaks are determined for dividing the content into multiple pages for display on a target display (e.g., a display of a client). For example, referring to FIG. 2, the content service 206 may obtain content from the content server 205 and may determine page breaks that divide the content into multiple pages based on display characteristics of a display associated with the browser component 216. As another example, a pagination component of a client that hosts the browser may receive the request, obtain content from the content server 205, and determine the page breaks from the content. As yet another example, referring to FIG. 3, pagination components may divide the graphic elements in the screen shot 315 into parts 325 where each part is to be displayed on a separate page of display of a client.

In determining page breaks, different mechanisms may be used. For example, in one mechanisms, determining page breaks may include:

1. Rendering the content to a virtual display;

2. Capturing a screen shot of the virtual display;

3. Identifying graphic elements of the screen shot; and

4. Dividing the content into multiple pages based on the graphic elements and one or more characteristics of the target display.

As another example, determining page breaks that divide the content into multiple pages may include:

1. Parsing code included in the content;

2. Identifying graphic elements represented by the code; and

3. Dividing the content into multiple pages based on the graphic elements and one or more characteristics of the target display.

As yet another example, determining page breaks that divide the content into multiple pages may include parsing the content to locate page break markers that are applicable to the target display and ignoring other page break markers that are inapplicable to the target display.

The examples of determining page breaks above are not intended to be all-inclusive or exhaustive. Indeed, based on the teachings herein, those skilled in the art may recognize other methods for determining page breaks that may be used without departing from aspects of the subject matter described herein.

At block 525, one or more navigation elements may be added to the pages before providing the pages to the browser component. As indicated previously, a navigation element may indicate another page of the content that is reachable from a currently displayed page. For example, referring to FIG. 3, the navigation elements 335-338 may be added to pages. Adding navigation elements may include adding one or more of a tab element, hyperlink element, number elements, other graphical elements, and the like.

At block 530, the pages are provided to the browser component. This may be done page at a time as requested by the browser component or in the case of pages that include page break markers, all pages corresponding to the requested content may be provided to the browser component. For example, referring to FIG. 2, the pagination components 220 of the content service 206 may provide one page at a time, as requested, to the client 207.

At block 535, other actions, if any, may be performed.

Turning to FIG. 6, at block 605, the actions begin. For example, referring to FIG. 2, the client 207 may seek to obtain content from the content server 205.

At block 610, a request for content is received. For example, referring to FIG. 2, the content server 205 may receive a request for content from the client 207.

At block 615, one or more characteristics of a target display are received. For example, referring to FIG. 2, the content server 205 may receive the display characteristics of a display of the client 205.

At block 620, the type of the target display is determined based on the one or more characteristics. For example, referring to FIG. 410, the display classifier 420 may determine the type of the display based on the characteristics. Determining a type of the target display may include determining a discrete classification (e.g., small, medium, large, some other classification, or the like) of the target display. The term “discrete” in the context means a classification that groups similar display characteristics in buckets instead of assigning continuous (e.g., real or some other infinitely variably value) to the type.

In one embodiment, instead of sending the display characteristics, the client may simply send the type. In this example, the actions associated with blocks 615 and 620 may be omitted.

At block 625, based on the type of display, page breaks are determined for dividing the content into multiple pages for display on the target display. For example, referring to FIG. 4, the screen shot manager 425, the graphic element identifier 430, and the page break manager 435 may be involved in steps to identify page breaks as has been described previously.

At block 630, in one embodiment, page break markers may be added so that the client browser may know how to divide the content into pages. For example, referring to FIG. 4, the page break manager 435 may add page break markers to pages to provide to a requesting client. The page break markers may have been added previous to the client requesting the content and other page break markers for other types of displays may also be added to content.

At block 635, navigation elements may be added. For example, referring to FIG. 4, the page provider 440 may embed links or other navigation elements in pages provided to a requesting client.

At block 640, the pages are provided to the client. For example, referring to FIG. 4, the page provider 440 may send pages (e.g., one or many at a time) to a client.

At block 645, other actions, if any, may be performed.

As can be seen from the foregoing detailed description, aspects have been described related to displaying content on multiple pages. While aspects of the subject matter described herein are susceptible to various modifications and alternative constructions, certain illustrated embodiments thereof are shown in the drawings and have been described above in detail. It should be understood, however, that there is no intention to limit aspects of the claimed subject matter to the specific forms disclosed, but on the contrary, the intention is to cover all modifications, alternative constructions, and equivalents falling within the spirit and scope of various aspects of the subject matter described herein.

What is claimed is:

1. A method implemented at least in part by a computer, the method comprising:
obtaining data that represents a set of three-dimensional objects;
determining candidate pairs for merging the three-dimensional objects, each candidate pair including two of the three dimensional objects;
determining a lowest cost pair of the candidate pairs, the lowest cost pair having a minimum merging cost;
merging the objects of the lowest cost pair into a merged object; and
storing data indicative of the lowest cost pair and indicative of a sequence of a merging order of pairs of the three dimensional objects.

2. The method of claim 1, wherein obtaining data that represent a set of three-dimensional objects comprises obtaining data corresponding to two dimensional slices of a three-dimensional object, the two dimensional slices collocated together.

3. The method of claim 1, wherein obtaining data that represents a set of three-dimensional objects comprises obtaining data corresponding to a set of voxels, each voxel having three dimensions.

4. The method of claim 1, wherein determining candidate pairs for merging the three-dimensional objects comprises determining objects that share at least one surface.

5. The method of claim 1, wherein determining a lowest cost pair of the candidate pairs comprises evaluating a merging cost function.

6. The method of claim 5, wherein evaluating a merging cost function comprises evaluating a function that accounts for radiometric similarity, texture similarity, distance, and compactness of two potential objects to merge.

7. The method of claim 1, wherein determining a lowest cost pair of the candidate pairs comprises determining a candidate pair that has a merging cost that is no larger than any other merging cost of the candidate pairs.

8. The method of claim 1, wherein merging the objects of the lowest cost pair into a merged object comprises creating a merged object that is associated with an identifier of one of the merged objects, updating a volume of the merged object to equal the volume of the merged objects, adding voxels of the merged objects to the merged object, updating a centroid of the merged object, determining neighboring objects of the merged object, determining surface areas between the merged object and the neighboring objects.

9. The method of claim 1, further comprising using the data structure to reverse the merging of the objects.

10. The method of claim 9, wherein using the data structure to reverse the merging of the objects comprises reverting to a snapshot taken just prior to merging the objects of the lowest cost pair into a merged object.

11. The method of claim 9, wherein using the data structure to reverse the merging of the objects comprises obtaining voxels of the lowest cost pair from the data structure and re-creating the objects of the lowest cost pair based thereon.

12. A computer storage medium having computer-executable instructions, which when executed perform actions, comprising:
obtaining a data structure that indicates merging steps performed to merge three-dimensional objects, the merging steps indicating a sequence in which pairs of the three dimensional objects were merged;
determining, via the data structure, two of the three-dimensional objects that were merged in a merging step of the merging steps; and
using the data structure to reverse a merge of the two three-dimensional objects to obtain a merging state prior to the merge.

13. The computer storage medium of claim 12, wherein obtaining a data structure that indicates merging steps to merge three-dimensional objects comprises obtaining a data structure that indicates identifiers of merged objects in an order in which the merged objects were merged.

14. The computer storage medium of claim 12, wherein obtaining a data structure that indicates merging steps to merge three-dimensional objects comprises obtaining a data structure that indicates voxels included in each object.

15. The computer storage medium of claim 12, wherein determining two of the three-dimensional objects that were merged in a merging step of the merging steps comprises locating identifiers of the two three-dimensional objects in the data structure, the identifiers previously created from a function that receives at least three parameters, the three parameters corresponding to a location of a voxel of a corresponding three-dimensional object.

16. The computer storage medium of claim 12, wherein using the data structure to reverse a merge comprises removing voxels of one of the two three-dimensional object from a merged object that includes voxels from the two three-dimensional objects.

17. In a computing environment, an apparatus, comprising:
a pair manager operable to determine candidate pairs for merging three-dimensional objects, each candidate pair including two of the three-dimensional objects;
a cost evaluator operable to determine merging costs for merging each candidate pair;
a merge manager operable to merge objects of a candidate pair into a merged object and to update properties of the merged object based on properties of the objects of the candidate pair; and
a history manager operable to update a data structure to indicate a sequence of merges of the three-dimensional objects including a merge that results in the merged object, such that the merge is reversible.

18. The apparatus of claim 17, wherein the cost evaluator is operable to determine merging costs for merging each candidate pair by being operable to evaluate a cost function that accounts for radiometric similarity, texture similarity, distance, and compactness of two potential objects to merge.

19. The apparatus of claim 17, wherein the merge manager is operable to update properties of the merged object by being operable to at least determine volume, surface area, and adjacent objects of the merged object.

20. The apparatus of claim 17, further comprising a reverse merge manager operable to use the data structure to reverse one or more merges of the candidate pairs.
